(19) United States
(12) Patent Application Publication
(10) Pub. No.: US 2021/0052462 A1
(43) Pub. Date: Feb. 25, 2021

(54) FOAM GLIDE

(71) Applicant: Joseph Crocco, Castiac, CA (US)

(72) Inventor: Joseph Crocco, Castiac, CA (US)

(21) Appl. No.: 16/546,126

(22) Filed: Aug. 20, 2019

(51) Int. Cl. A61H 15/00; A63B 21/00; A63B 22/20

(52) U.S. Cl. CPC A61H 15/00; A63B 21/4033; A63B 22/203; A63B 2208/0252; A61H 2015/0014; A61H 2201/1261; A61H 2201/169; A63B 21/4035

(57) ABSTRACT

An exercise apparatus, comprising an elongate base platform having a top planar surface, bottom planar surface, a depth, a length and a width. A seat assembly is supported by the base, the seat assembly includes a top planar surface, a bottom surface and wheels attached to the bottom surface. A pliable rolling device is utilized with the apparatus, wherein channels are formed in the depth on the top planar surface of the base platform enabled to accept the wheels and with a first area of a user resting on the seat assembly, a second area of a user resting on the foam roller, the user translates the seat assembly along the channels causing the second area to be translated on the foam roller.

### CROSS-REFERENCE TO RELATED DOCUMENTS

N/A

### BACKGROUND OF THE INVENTION

### 1. Field of the Invention

The present invention is in the field of physical therapy apparatus as it relates to exercise apparatus, and more particularly, to an auxiliary foam roller exercise support apparatus.

### 2. Discussion of the State of the Art

Adhesions and scar tissue commonly form as a result of invasive surgeries and injuries. When injured surfaces are close together, the body attempts to heal itself and can cause scar tissue to grow and create a bond between surfaces that were not connected prior to the operation or injury. Additional, general muscle pain may originate from a variety of exercises performed by a user to an extent to cause muscle soreness. Stress may also cause muscle pain and soreness.

Massage has been identified as an effective means to improve blood circulation to relieve muscle, skeletal and other connective tissue discomfort; to increase joint range of motion; and to aid in reducing the development of adhesions as wounds heal. Successful slowing, preventing or non-surgically releasing adhesions through massage may help to avoid a repetitious cycle of surgery, healing and adhesion formation.

Persons trained in massage are certified to perform treatment on patients who have developed or are likely to develop adhesions. Treatment may be performed in a hospital or clinic requiring travel by the patient. It may be performed in the patient's home, but often at an increased cost for those services. It is also possible for a patient to be instructed in methods to “self-massage” in an in-home environment, thereby reducing cost and time commitments and providing scheduling flexibility.

A variety of firm foam rollers have been developed and are marketed for use for self-massage by patients and athletes for physical therapy, pain relief and exercise. In general, the user works on a firm flat surface such as a mat on the floor. In most cases the user places the roller perpendicular to the axis of the body under the area of the body where the muscle soreness or adhesions are. The user arranges his or her body to a position recommended for the specific massage to be performed. Usually such positions require that there are one or two points of contact between the body and the mat, for example an arm and a leg, and a point of contact between the affected body part and the foam roller. This positioning transfers a significant portion of the body weight to rest on the roller, causing a reactive force to be imparted upon the muscle resting on the roller. Properly positioned, the user can then use other body parts in contact with the mat to move the body back and forth in relation to the foam roller in a longitudinal direction. This movement back and forth causes the weight on the roller and the force of the mat below to cause the roll to rotate smoothly up and down the length of the treatment area.

Utilizing the foam roller on its own requires considerable strength and agility to support the body in the recommended positions and to move the body mass in the required directions. Pain or discomfort, or lack of strength can discourage or prevent patients from performing self-massage with a foam roller. The user may be incapable of holding the positions required to effectively perform self-massage.

The Foam Glide assist device is intended to aid a user who may be physically compromised to utilize the foam roller. The device may be used in physical therapy applications, gyms, classes and for individual home use, as well.

### SUMMARY OF THE INVENTION

An exercise apparatus is provided in a first embodiment including an elongate base platform having a top planar surface, bottom planar surface, a depth, a length and a width. A seat assembly supported by the base, the seat assembly may include a top planar surface, a bottom surface and wheels attached to the bottom surface. A pliable rolling device is also implemented in the use of the apparatus.

In this embodiment, channels are formed in the depth on the top planar surface of the base platform enabled to accept the wheels and with a first area of a user resting on the seat assembly, a second area of a user resting on the foam roller, the user translates the seat assembly along the channels causing the second area to be translated on the foam roller.

One embodiment provides handrails that may be attached to the base platform outside of the channels enabling a user to engage a third area of the user thereby applying force at the seat assembly causing translation within the channels. In this embodiment, a plurality of braces connect the base platform to the handrails, with the handrails extending linearly away from the base platform.

Another embodiment provides that the base platform is rectangular having a first and second length and a first and second width, and one handrail is attached to and runs along the first length and another handrail is attached to and runs along the second length.

A method for using the exercise apparatus with a foam roller, is also provided. In this embodiment, a user places an area of his or her body weight on a top surface of a platform mounted on wheels and is translatable via channels formed within a depth of a top surface of an elongate planar platform base, the channels enabled to accept the wheels. The user then bears a second area of body weight on a pliable rolling device and the platform is translated via the wheels in the channel, thereby causing the foam roller to translate the second area of body weight.

In one embodiment, the handrails are attached to the base platform outside of the channels enabling a user to engage a third area of the user thereby applying force at the seat assembly causing translation within the channels. Additionally, a plurality of braces connect the base platform to the handrails, with the handrails extending linearly away from the base platform.

One embodiment provides that the base platform is rectangular having a first and second length and first and second ends having a width, and one handrail is attached to and runs along the first length and another handrail is attached to and runs along the second length. In this embodiment, a third area of the user's body is a user's hand, that grasps the handrail, thereby applying force that moves the platform via the wheels in the channels. The ends of the platform may be capped thereby preventing the wheels from leaving the channels at either end.

### BRIEF SUMMARY OF THE INVENTION

The present invention assists with self-massage utilizing a foam roller to apply force to generate tension to breakdown surgical adhesions and scar tissue, to improve blood flow to those areas, and to increase mobility. This foam roller assist device is comprised of three main components including the smooth flat base platform, a sliding seat mechanism which supports a portion of the body's weight such that it can easily be moved in a forward and back direction. Handrails enable the user to grip while pulling or pushing to move the body mass on the seat in relation to the platform and the foam roller.

### BRIEF DESCRIPTION OF THE SEVERAL VIEWS OF THE DRAWINGS

FIG. 1 is a perspective view of the device and a foam roller.

FIG. 2 is a plan view of the device.

FIG. 3 is a bottom view of the device.

FIG. 4A is a side elevation view of the device.

FIG. 4B is a lengthwise cut view of the device.

FIG. 5A is an end view of the device.

FIG. 5B is crosswise cut view of the device.

FIG. 6A is a bottom view of sliding seat.

FIG. 6B is an end view of wheel assembly.

FIG. 6C is a side view of wheel assembly.

FIG. 6D is a cross section view of wheels in track.

FIG. 7A provides an example view of treating back of legs.

FIG. 7B provides an example view of treating front of legs.

FIG. 7C provides an example view of treating upper back.

### DETAILED DESCRIPTION OF THE INVENTION

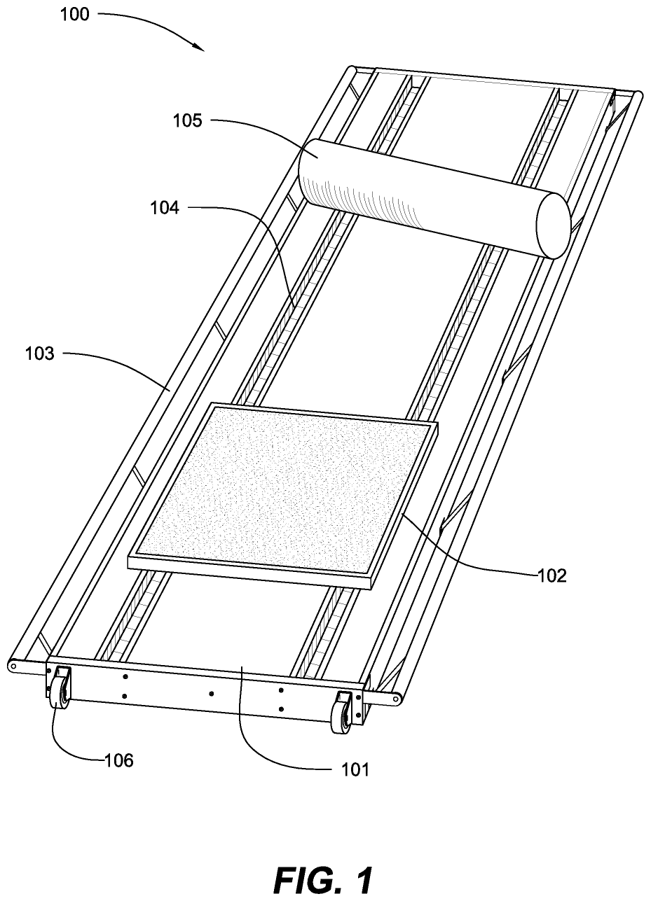

FIG. 1 provides a preferred embodiment of assist device 100 to enable physically compromised or less able persons to use in conjunction with a foam roller 105 to perform self-massage in a clinic setting, in a classroom, at home or while traveling. Device 100 is comprised of a sturdy base platform 101, an affixed sliding seat assembly 102, and attached handrails 103 along each side of platform 101. Seat 102 travels the length of the platform in integrated tracks 104. Foam roller 105 may be one of many types of commercially available styles including cylinders, tubes, spheres, etc. and may be of varying diameter, materials, firmness and texture. Device 100 may be equipped with wheels 106 on one end allowing the user to lift the device by handrails 103 at the opposite end and wheel the device to a new location of use or to storage.

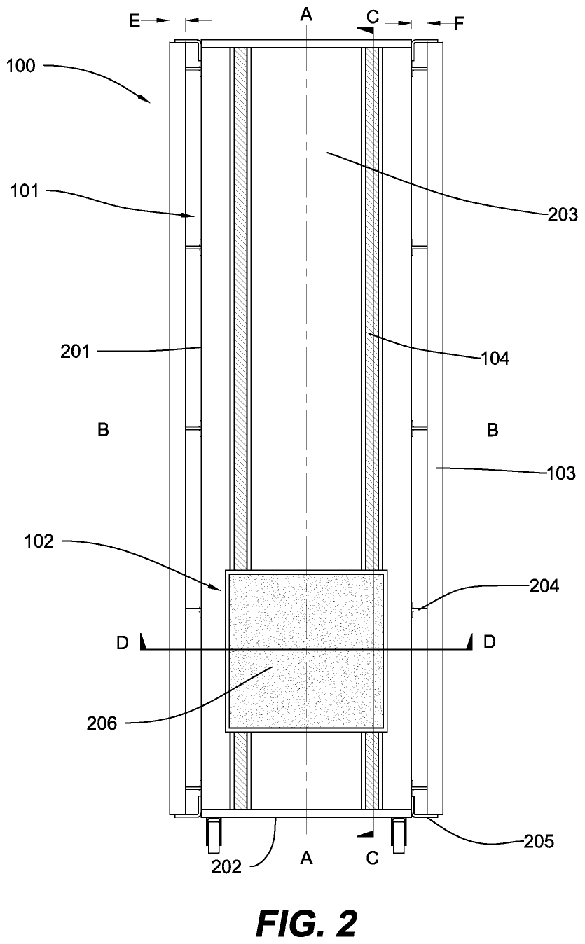

FIG. 2 provides a plan view of device 100. Platform 101 is symmetrical along its lengthwise centerline axis A-A and crosswise centerline B-B. Section lines C and D are described in a later figure. Device 100 can be used with the head at either end. Platform 101 has side frame pieces 201 on each side and end frame pieces 202 at each end. It has a firm flat platform surface 203 extending from side frame 201 to the opposite side frame and from end frame 202 to the opposite end frame. Tracks 104 are installed such that they are flush with surface 203. Handrails 103 are affixed to side frames 201 with diagonal handrail support brackets 204 equally spaced along each side and with end support angles 205 at each end. In addition to adding support, they prevent exposed ends of handrail 103 that can cause a tripping hazard or can hook loose clothing. Handrails have a Diameter E in the range of 1¼ inch minimum to 2 inch maximum, as is typical of handrails for staircases. Handrails may be tubular to fit a user's hand and installed as to extend linearly from the side frames. They are installed a minimum Distance F of 1½ inch from side frame 201 to provide clearance for a safe ergonomic grip.

Platform 101, seat 102 and handrails 103 in this embodiment are illustrated in wood. Other embodiments of the device could make use of materials such as fiberglass or durable plastics. All surfaces of device 100 shall be manufactured with a smooth finish to enhance their function. The top surface 206 of seat 102 shall be treated with a non-skid material to provide friction to effectively transfer force from the body to move the seat in the desired direction.

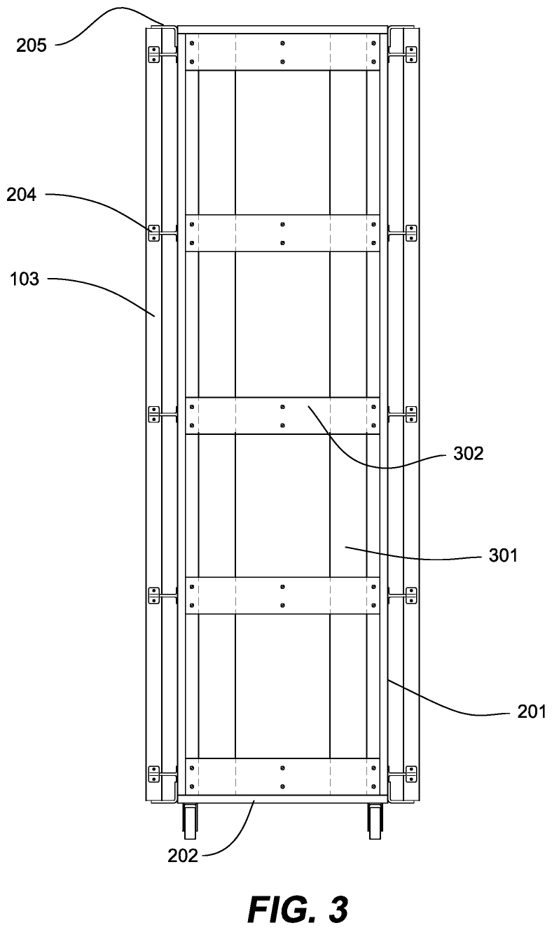

FIG. 3 provides a view of the underside of platform 101 and handrails 103. Supports 204 can more clearly be seen to attached to the underside of handrail 103 to avoid interference with grip on the handrail. This figure also shows the lengthwise support members 301 and the crosswise support members 302. These members provide support to integral tracks 104 as well as tying together side frame members 201, end frame members 202 and surface 203 into a firm rigid platform to support the user's weight and dynamic forces of movement.

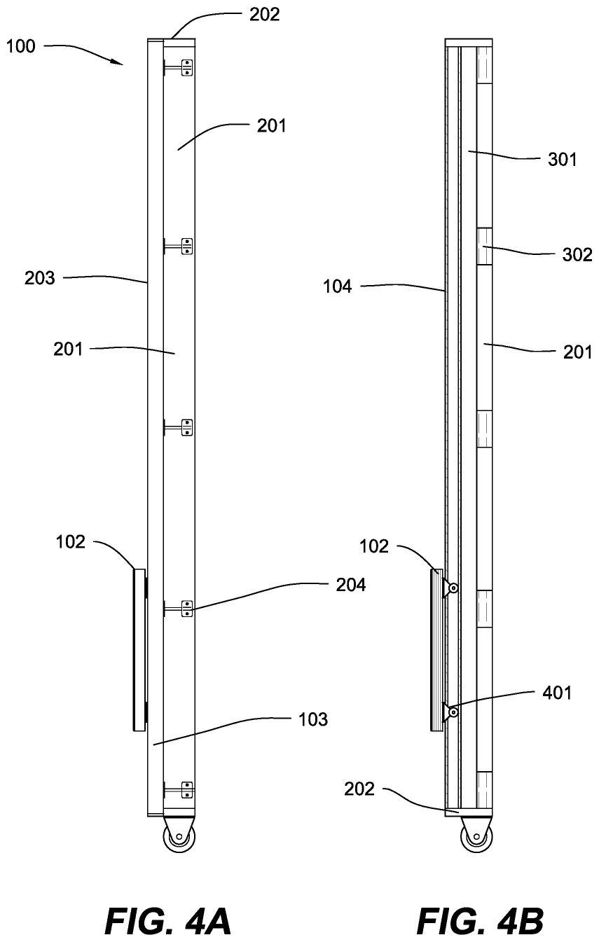

FIG. 4A shows a side view of device 100. Handrails 103 can be seen supported by brackets 204. FIG. 4B shows a lengthwise cut view of device 100 along Section C-C indicated on FIG. 2 along the center of track 104. The top surface of track 104 is flush with the top of surface 203 and the tops of side frame 201 called out in FIG. 4A to the left. Wheel assemblies 401 roll in recessed tracks 104. Lengthwise supports 301 and crosswise supports 302 can be seen in this section view.

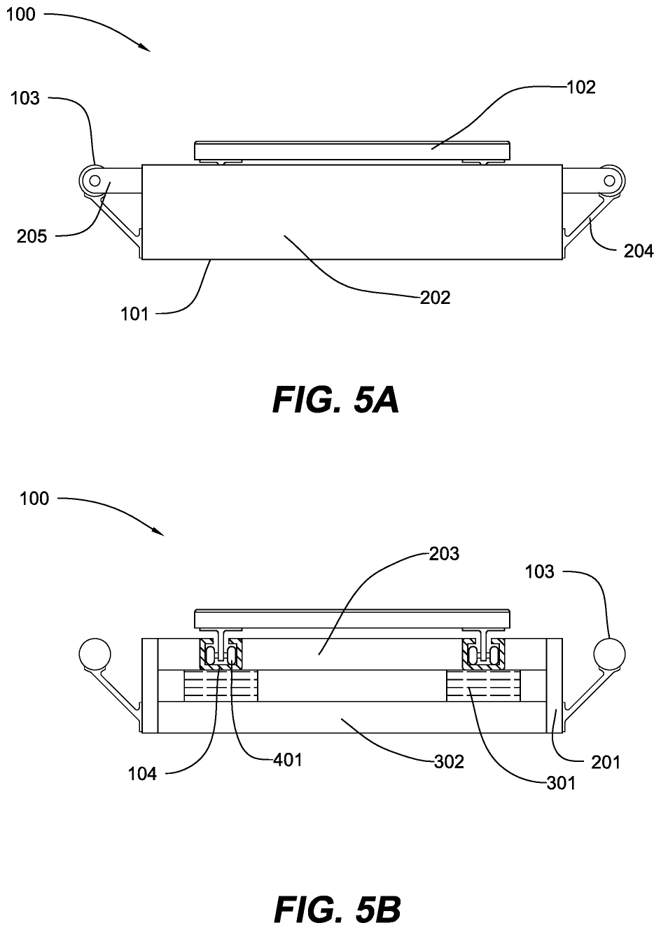

FIG. 5A shows an end view of device 100. Handrail end brackets 205 can be seen on each side. FIG. 5B shows a section view taken along Section D-D in FIG. 2. This view shows how side-by-side wheel assemblies 401 fit encompassed within tracks 104. End frames 202 create closures to tracks 104 such that the wheeled seat stays with platform 101.

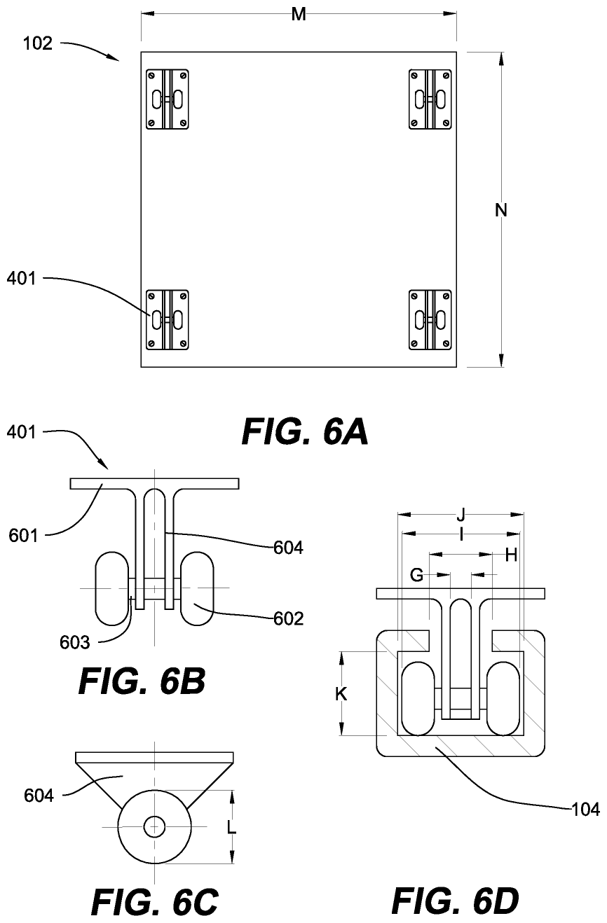

FIG. 6A provides a bottom view of seat 102. Wheeled assemblies 401 are affixed to the bottom of seat 102. FIG. 6B provides a front and FIG. 6C provides a side view of an example of side-by-side wheel assembly 401 that will work in this configuration. The flanges are screwed to the bottom of seat 102. Durable metal, rubber or plastic wheels 602 are mounted on axle 603 through a double bracket web 604. Width M of seat 102 in this example is approximately 14½ inches. Seat 102 should be slightly narrower than base platform 101 so that there is no interference with the user's hand or arm while gripping handrail 103. Seat 102 Length N in this example is 14½ inches but could be slightly shorter or longer in other embodiments of this device. The corners of seat 102 are depicted as square but may be radiused in other embodiments.

FIGS. 6C and 6D (cross-section) shows that thickness Dimension G of web 604 of bracket 601 is narrower than the width Dimension H of the opening of track 104. The combined width Dimension I of wheels 602 is greater than Dimension H keeping wheels 602 secured inside track 104. Dimension I is narrower than inside width Dimension J of track 104 and diameter Dimension L of wheel 602 is smaller than the inside height Dimension J of the track to allow the wheels to roll easily inside.

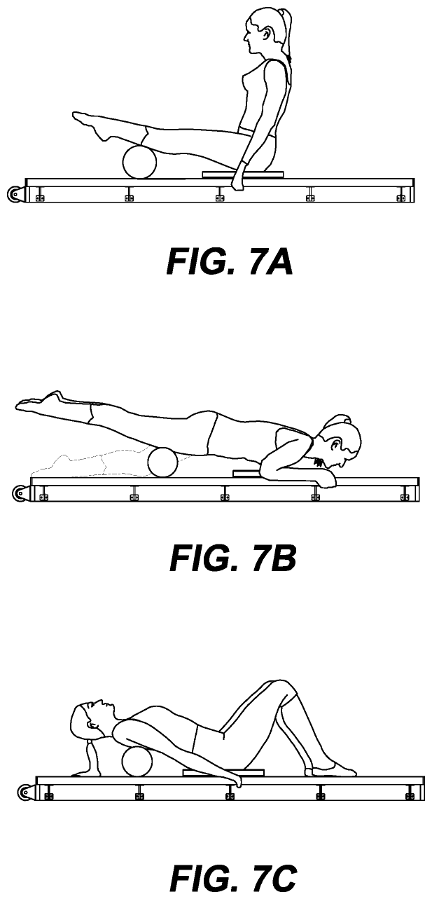

FIG. 7A shows a user in the proper position to self-massage the back of the legs. The user sits upright on seat 102 in the center of platform 101 with legs extended straight out toward one of the ends 202 with roller 105 placed beneath the legs. The user grips handrails 103 on each side of the device and slowly pulls and pushes so that roller 105 massages the underside of the legs. This massage can be used from the Achilles tendon to the upper hamstring area of the quad.

FIG. 7B demonstrates a user in position to self-massage the front of the quads. The user lies with chest on seat 102 near the center of platform 101 with toes pointed toward end frame 202 and places roller 105 under one or both quads. Gripping handrails 103 on each side of the platform, the user can pull or push to move the platform forward and back longitudinally along platform 101, thus massaging from the hips down to the knees. The user may pause when roller 105 is under a tight or painful area to work out tension. The user may place roller 105 on an underside of one or both thighs based on preference. The other leg may rest on the smooth surface of platform 101 as suggested by the dashed outline in this figure.

FIG. 7C depicts a user in position to self-massage the upper area of the back. In this figure, the user is seated on seat 102 positioned near the center of platform 101 reclining back onto foam roller 105. The user's feet may be placed on the platform to exert force to move seat 102 forward and back such that the area of the back to be treated moves over roller 105. The user may choose to utilize handrails 103 or not subject to preference. In this example, all of the user's body weight, or a majority of the user's bodyweight is distributed and supported between the seat 102 and roller 105. In some embodiments, no part of a user's body rests upon platform 101 and all of the bodyweight is distributed between the roller 105 and seat 102.

As another example, not illustrated here, the user may self-massage the outer thigh or IT bands. The user lies on her side placing the left arm on seat 102 and placing roller 105 under the left thigh. The user supports her weight on the left arm and foam roller 105, with the back straight and toes parallel and pointed toward end 202. In this example, the user will lower her right arm and grasp handrail 103 with her right hand. Exerting force on handrail 103 toward the hips will cause seat 102 and the user's body to move in the direction of the head. Exerting force on handrail 103 toward the shoulders and head will move seat 102 and the user's body to move in the other direction. These movements will cause roller 105 to massage the thigh as the body moves forward and back over the roller.

These demonstrations are several of many various positions that may be implemented with device 100 to self-massage other body parts with one or more styles of foam rollers. The skilled person will understand that all of the embodiments and variations described above are entirely exemplary, and not limiting. There may be many different implementations of apparatus in different embodiments and many different interactive interfaces in remote control apparatus, including smart phones or tablets, for a variety of purposes. Different apparatus may have different numbers of arms, and lengths of arms, among other differences within the scope of the invention. The invention is limited only by the claims that follow.

1. An exercise apparatus, comprising:
an elongate base platform having a top planar surface, bottom planar surface, a depth, a length and a width;
a seat assembly supported by the base, the seat assembly including a top planar surface, a bottom surface and wheels attached to the bottom surface;
a pliable rolling device
wherein channels are formed in the depth on the top planar surface of the base platform enabled to accept the wheels and with a first area of a user resting on the seat assembly, a second area of a user resting on the foam roller, the user translates the seat assembly along the channels causing the second area to be translated on the foam roller.

2. The apparatus of claim 1, wherein handrails are attached to the base platform outside of the channels enabling a user to engage a third area of the user thereby applying force at the seat assembly causing translation within the channels.

3. The apparatus of claim 2, wherein a plurality of braces connect the base platform to the handrails, with the handrails extending linearly away from the base platform.

4. The apparatus of claim 3, wherein the base platform is rectangular having a first and second length and a first and second width, and one handrail is attached to and runs along the first length and another handrail is attached to and runs along the second length.

5. A method for using an exercise apparatus with a foam roller, comprising the steps of:
(a) bearing a first area of body weight of a user on a top surface of a platform mounted on wheels and translatable via channels formed within a depth of a top surface of an elongate planar platform base, the channels enabled to accept the wheels;
(b) bearing a second area of body weight of a user on a pliable rolling device; and
(c) translating the platform via the wheels in the channel, thereby causing the foam roller to translate the second area of body weight.

6. The method of claim 5, wherein handrails are attached to the base platform outside of the channels enabling a user to engage a third area of the user thereby applying force at the seat assembly causing translation within the channels.

7. The method of claim 6, wherein a plurality of braces connect the base platform to the handrails, with the handrails extending linearly away from the base platform.

8. The method of claim 7, wherein the base platform is rectangular having a first and second length and first and second ends having a width, and one handrail is attached to and runs along the first length and another handrail is attached to and runs along the second length.

9. The method of claim 6, wherein the third area is a user's hand that grasps the handrail, thereby applying force that moves the platform via the wheels in the channels.

10. The method of claim 8, wherein the ends are capped thereby preventing the wheels from leaving the channels at either end.
